(19) United States
(12) Patent Application Publication
(10) Pub. No.: US 2025/0334980 A1
(43) Pub. Date: Oct. 30, 2025

(54) SYSTEMS, APPARATUSES, METHODS, AND COMPUTER PROGRAM PRODUCTS FOR IMPROVED FLIGHT OPERATION MONITORING

(71) Applicant: Honeywell International Inc., Charlotte, NC (US)

(72) Inventors: Suhail Ahamed, Bangalore (IN); George Rajan Koilpillai, Bangalore (IN); Chenchu Lokanadham B, Madurai (IN)

(21) Appl. No.: 19/193,260

(22) Filed: Apr. 29, 2025

(30) Foreign Application Priority Data
Apr. 30, 2024 (IN) 202411034180

(51) Int. Cl. G05D 1/86; G07C 5/08

(52) U.S. Cl. CPC G05D 1/86; G07C 5/0816

(57) ABSTRACT

Various embodiments of the present disclosure provide techniques for improved flight operation monitoring. The techniques may include identifying one or more rule activation conditions associated with a rule creation request for temporary monitoring of one or more flight operational parameters associated with a flight operation; identifying one or more rule triggering conditions associated with the rule creation request; monitoring one or more conditions based on the one or more rule activation conditions; in response to determining that the one or more conditions satisfy the one or more rule activation conditions, monitoring the one or more flight operational parameters based on the one or more rule triggering conditions; and causing rendering of a user interface comprising a message when the one or more flight operational parameters satisfy the rule triggering conditions.

### CROSS REFERENCE TO RELATED APPLICATIONS

This application claims priority to India application No. 202411034180, filed on Apr. 30, 2024, the contents of which are hereby incorporated herein by reference in their entirety.

### TECHNOLOGICAL FIELD

The present disclosure relates, generally, to systems, apparatuses, methods, and computer program products for improved flight operation monitoring. Example embodiments are directed to systems, apparatuses, methods, and computer program products for improved flight operation monitoring that allows for user-defined rules.

### BACKGROUND

Various embodiments of the present disclosure address technical challenges related to improved flight operation monitoring. Through applied effort, ingenuity, and innovation, Applicant has solved problems related to flight operation monitoring by developing solutions embodied in the present disclosure, which are described in detail below.

### BRIEF SUMMARY

In general, embodiments of the present disclosure provide systems, apparatuses, methods, and computer program products for improved flight operation monitoring.

In accordance with an aspect of the disclosure a computer-implemented method for improved flight operation monitoring is provided. In an example embodiment, the computer-implemented method comprises identifying one or more rule activation conditions associated with a rule creation request for temporary monitoring of one or more flight operational parameters associated with a flight operation; identifying one or more rule triggering conditions associated with the rule creation request; monitoring one or more conditions based on the one or more rule activation conditions by comparing the one or more conditions to the one or more rule activation conditions; in response to determining that the one or more conditions satisfy the one or more rule activation conditions, monitoring the one or more flight operational parameters based on the one or more rule triggering conditions by comparing the one or more flight operational parameters to the one or more rule triggering conditions; and causing rendering of a user interface comprising an alert message when the one or more flight operational parameters satisfy the one or more rule triggering conditions.

In accordance with another aspect of the disclosure, a computing system for improved flight operation monitoring is provided. In an example embodiment, the computing system comprises memory and one or more processors communicatively coupled to the memory, the one or more processors configured to identify one or more rule activation conditions associated with a rule creation request for temporary monitoring of one or more flight operational parameters associated with a flight operation; identify one or more rule triggering conditions associated with the rule creation request; monitor one or more conditions based on the one or more rule activation conditions by comparing the one or more conditions to the one or more rule activation conditions; in response to determining that the one or more conditions satisfy the one or more rule activation conditions, monitor the one or more flight operational parameters based on the one or more rule triggering conditions by comparing the one or more flight operational parameters to the one or more rule triggering conditions; and cause rendering of a user interface comprising an alert message when the one or more flight operational parameters satisfy the one or more rule triggering conditions.

In accordance with another aspect of the disclosure, at least one non-transitory computer-readable storage medium for improved flight operation monitoring is provided, the at least one non-transitory computer-readable storage medium having computer coded instructions configured to, when executed by at least one processor: identify one or more rule activation conditions associated with a rule creation request for temporary monitoring of one or more flight operational parameters associated with a flight operation; identify one or more rule triggering conditions associated with the rule creation request; monitor one or more conditions based on the one or more rule activation conditions by comparing the one or more conditions to the one or more rule activation conditions; in response to determining that the one or more conditions satisfy the one or more rule activation conditions, monitor the one or more flight operational parameters based on the one or more rule triggering conditions by comparing the one or more flight operational parameters to the one or more rule triggering conditions; and cause rendering of a user interface comprising an alert message when the one or more flight operational parameters satisfy the one or more rule triggering conditions.

It should be appreciated that any and/or all aspects and/or operations of the example computer-implemented methods described herein may be combinable with any other of the aspects and/or operations of any other of the example computer-implemented methods described herein.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a signal diagram of an example process for improved flight operation monitoring in accordance with some embodiments discussed herein.

FIG. 5 is a signal diagram of an example process for improved flight operation monitoring in accordance with some embodiments discussed herein.

FIG. 6 is a flowchart diagram of an example process for improved flight operation monitoring in accordance with some embodiments discussed herein.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### Overview and Technical Improvements

Example embodiments disclosed herein address technical challenges associated with monitoring flight operations configured to provide situational awareness to flight crew such as a pilot. Flight management systems (FMS) may be configured to implement logic to trigger advisory/alerting messages in a multifunction control display unit (MCDU)/touchscreen controller (TSC) scratchpad when specific conditions are met during flight. During flight operations there may be a need to implement a new advisory/alerting message that would potentially provide situational awareness to the pilot. A new implementation would require update to the software (e.g., flight management system) and undergo certification consideration, which requires additional cost and cycle time to implement.

Example embodiments of the present disclosure provide a computing system configured for implementing a temporary advisory/alerting message during a flight operation for a particular route, aircraft, and/or situation (e.g., for enhanced situational awareness) using user-defined rules and monitoring systems, such as connected flight management systems, without actual update to the software. Example embodiments use monitoring systems, such as connected flight management systems, that is capable to log and/or output flight plan buffer data which include flight plan elements such as flight phase, lateral leg data, vertical data, performance initialization data, etc.

Example embodiments provide for a pilot, external client, airline operator, etc. to create user-defined rules (e.g., customizable and modifiable per user) for monitoring one or more flight operational parameters associated with a flight operation. In example embodiments the computing system is configured to implement user-defined rules by determining when rule activation condition(s) have been satisfied, initiating a monitoring process (e.g., flight management system monitoring, or the like) when the rule activation condition(s) have been satisfied to determine whether measured data for specified flight operational parameters (e.g., specified in via user-defined rules) satisfy one or more rule triggering conditions, generate an advisory message, alert message, reminder message, and/or the like when the one or more rule triggering conditions are satisfied, and provide the advisory message, alert message, reminder message, and/or the like to the pilot, air traffic control members, and/or other users that will reduce the user workload, improve efficiency while avoiding hazardous or critical issues, reduce cost, and reduce cycle time.

### Definitions

Many modifications and other embodiments of the disclosure set forth herein will come to mind to one skilled in the art to which this disclosure pertains having the benefit of the teachings presented in the foregoing description and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

### EXAMPLE SYSTEMS AND APPARATUSES OF THE DISCLOSURE

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

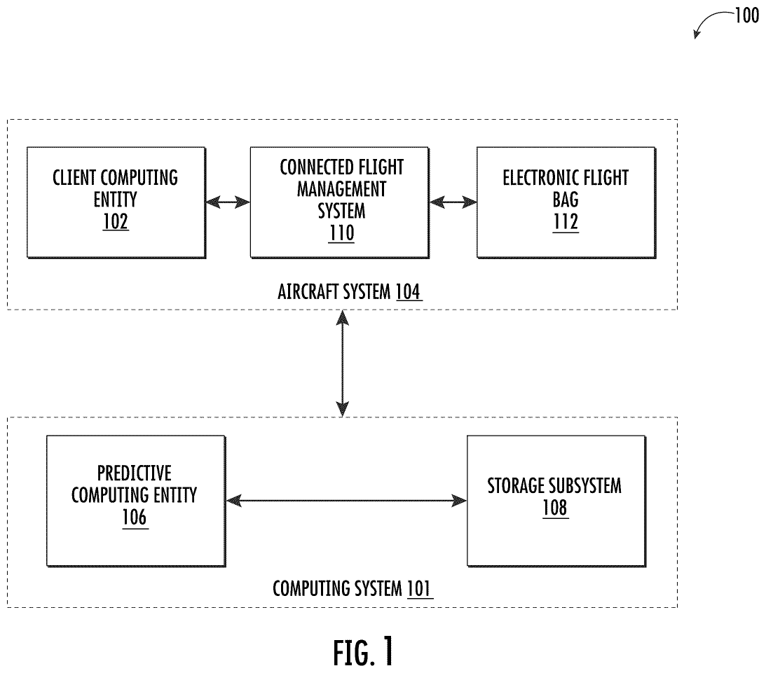

In this regard, FIG. 1 provides an example overview of an architecture 100 in accordance with some embodiments of the present disclosure. The depiction of the example architecture 100 is not intended to limit or otherwise confine the embodiments described and contemplated herein to any particular configuration of elements or systems, nor is it intended to exclude any alternative configurations or systems for the set of configurations and systems that can be used in connection with embodiments of the present disclosure. Rather, FIG. 1 and the architecture 100 disclosed therein is merely presented to provide an example basis and context for the facilitation of some of the features, aspects, and uses of the methods, apparatuses, computer readable media, and computer program products disclosed and contemplated herein. It will be understood that while many of the aspects and components presented in FIG. 1 are shown as discrete, separate elements, other configurations may be used in connection with the methods, apparatuses, computer readable media, and computer programs described herein, including configurations that combine, omit, separate, and/or add aspects and/or components.

The architecture 100 includes a computing system 101 configured to receive and/or generate requests, such as rule creation requests, process the rule creation requests by monitoring one or more flight operational parameters, generate message outputs such as advisory message, alert message, reminder message, or the like, and provide the generated message outputs to the aircraft system 104. The example architecture 100 may be used in a plurality of domains and not limited to any specific application as disclosed herewith. In particular, while some example embodiments are described herein with reference to the aviation domain, the example architecture 100 may be used in a plurality of domains and not limited to any specific application as disclosed herein. The plurality of domains may include aviation, banking, healthcare, industrial, manufacturing, education, retail, to name a few.

In some embodiments, the computing system 101 may communicate with the aircraft system 104 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may include a predictive computing entity 106 and a storage subsystem 108. The predictive computing entity 106 may be configured to receive and/or generate rule creation requests, process the rule creation requests by monitoring one or more flight operational parameters, generate message outputs such as advisory message, alert message, reminder message, or the like, and provide the generated message outputs to the aircraft system 104.

The storage subsystem 108 that may be configured to store data such as rule creation requests, rule activation conditions, rule triggering conditions, flight operational parameters, monitoring data, or the like, that may be used by the predictive computing entity 106 to perform predictive data analysis of the present disclosure. The storage subsystem may include one or more storage units, such as multiple distributed storage units that are connected through a computer network. Each storage unit in the respective computing entities may store at least one of one or more data assets and/or one or more data about the computed properties of one or more data assets. Moreover, each storage unit in the storage systems may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

The aircraft system 104 may include a client computing entity 102, a connected flight management system 110, and an electronic flight bag 112. The connected flight management system 110 may be configured to collect measured data for various flight operational parameters. For example, the connected flight management system may be configured to log and/or output flight plan data (e.g., flight plan buffer data) which may comprise flight plan elements such as flight phase, lateral leg data, vertical data, performance initialization data, and/or the like. The electronic flight bag may be configured to host one or more applications leveraged by a user (e.g., flight crew, etc.) to perform various functionalities associated with a flight operation including, but not limited to, storing data and performing flight-related calculations.

The client computing entity 102 may be configured to perform and/or facilitate various functionalities associated with the aircraft system 104 including, but not limited to, send and/or receiving data to and/or from the predictive computing entity 106. For example, the client computing entity 102 may be leveraged by a user (e.g., a pilot, air traffic controller member, or the like) to send rule creation requests to the predictive computing entity 106, receive request to accept or reject created rules. In some examples, a user interface comprising advisory message, alert message, reminder message, or other message outputs from the computing system 101 may be rendered on a display of a client computing entity.

### A. Example Predictive Computing Entity

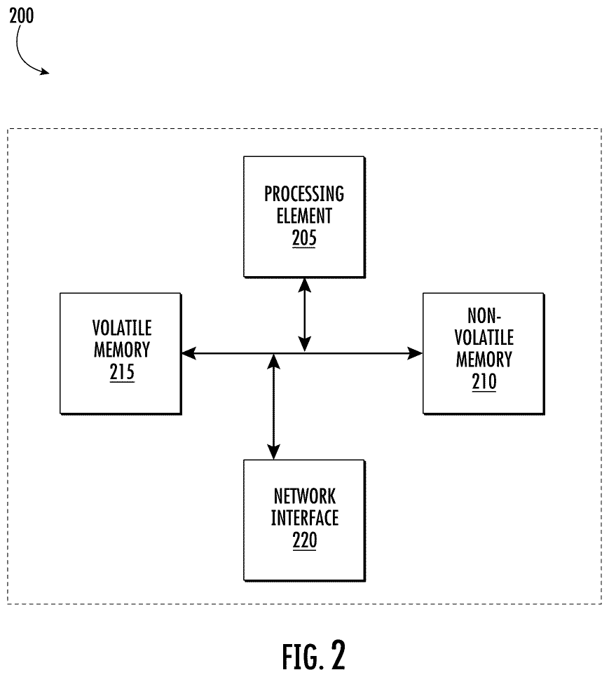

FIG. 2 provides an example computing entity 200 in accordance with some embodiments of the present disclosure. The computing entity 200 is an example of the predictive computing entity 106 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably.

As shown in FIG. 2, in some embodiments, the computing entity 200 may include, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further include, or be in communication with, non-volatile media (also referred to as non-volatile storage, memory, memory storage, memory circuitry, and/or similar terms used herein interchangeably). In some embodiments, the non-volatile media may include one or more non-volatile memory 210, including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

As will be recognized, the non-volatile media may store databases, database instances, database management systems, data, applications, programs, program modules, scripts, code (e.g., source code, object code, byte code, compiled code, interpreted code, machine code, etc.) that embodies one or more machine learning models or other computer functions described herein, executable instructions, and/or the like. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In some embodiments, the computing entity 200 may further include, or be in communication with, volatile media (also referred to as volatile storage, memory, memory storage, memory circuitry, and/or similar terms used herein interchangeably). In some embodiments, the volatile media may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, code (source code, object code, byte code, compiled code, interpreted code, machine code) that embodies one or more machine learning models or other computer functions described herein, executable instructions, and/or the like being executed by, for example, the processing element 205. Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 with the assistance of the processing element 205 and operating system.

As indicated, in some embodiments, the computing entity 200 may also include one or more network interfaces 220 for communicating with various computing entities (e.g., the client computing entity 102, etc.), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may include, or be in communication with, one or more input elements, such as a keyboard input, a mouse input, a touch screen/display input, motion input, movement input, audio input, pointing device input, joystick input, keypad input, and/or the like. The computing entity 200 may also include, or be in communication with, one or more output elements (not shown), such as audio output, video output, screen/display output, motion output, movement output, and/or the like.

### B. Example Client Computing Entity

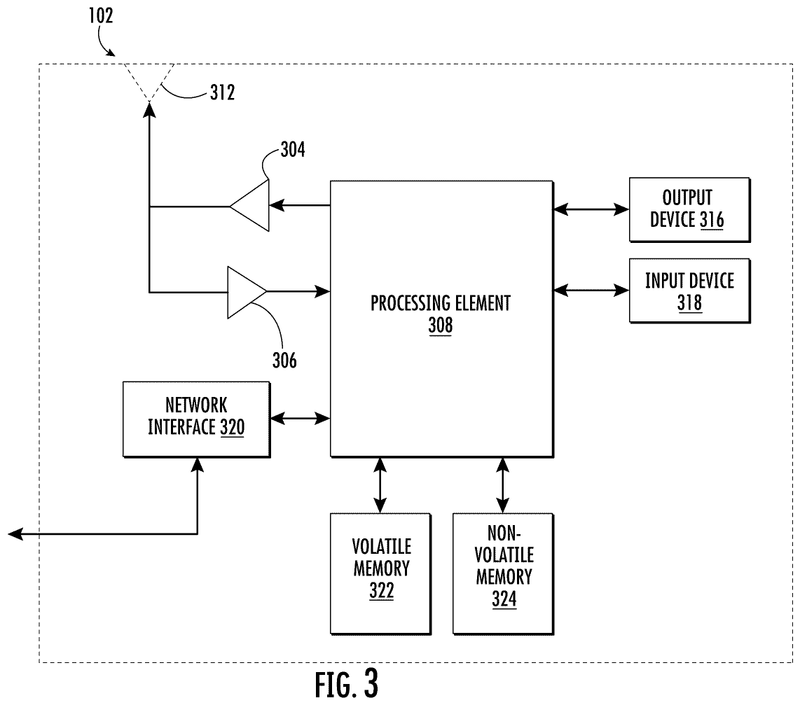

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the computing entity 200. In some embodiments, the client computing entity 102 may operate in accordance with multiple wireless communication standards and protocols, such as UMTS, CDMA2000, 1×RTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the computing entity 200 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download code, changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include an output device 316 (e.g., display, speaker, tactile instrument, etc.) coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the computing entity 200, as described herein. The user input interface may comprise any of a plurality of input devices 318 (or interfaces) allowing the client computing entity 102 to receive code and/or data, such as a keypad (hard or soft), a touch display, voice/speech or motion interfaces, or other input device. In some embodiments including a keypad, the keypad may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, code (source code, object code, byte code, compiled code, interpreted code, machine code, etc.) that embodies one or more machine learning models or other computer functions described herein, executable instructions, and/or the like to implement the functions of the client computing entity 102. As indicated, this may include a user application that is resident on the client computing entity 102 or accessible through a browser or other user interface for communicating with the computing entity 200 and/or various other computing entities.

In another embodiment, the client computing entity 102 may include one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### EXAMPLE SYSTEM OPERATIONS

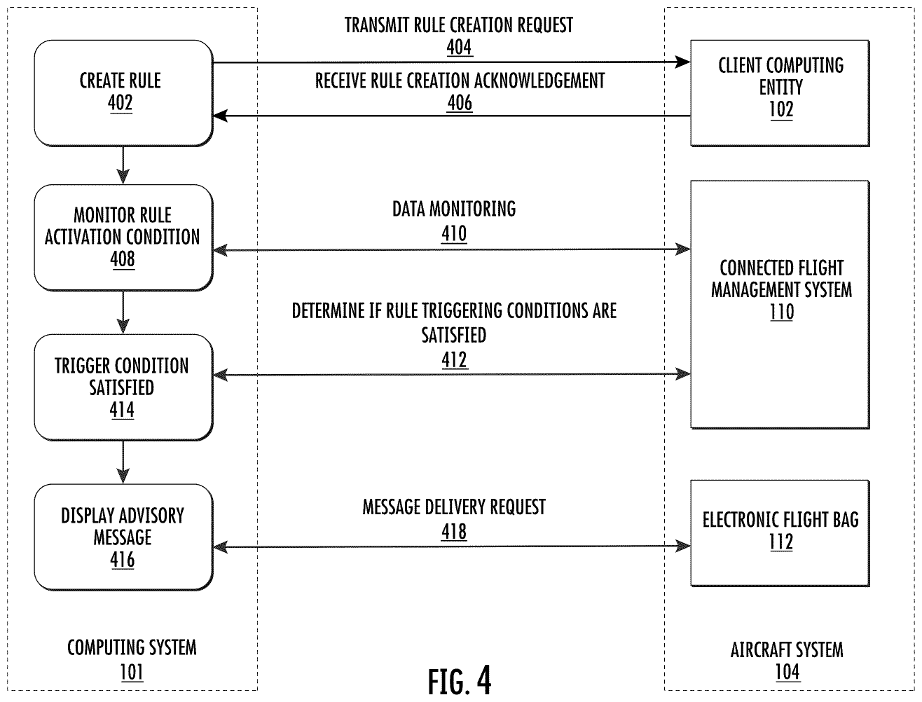

FIG. 4 is a signal diagram of an example process for improved flight operation monitoring. Specifically, FIG. 4 illustrates a signal diagram of an example process for creating user-defined monitoring rules, originating from an external client, and monitoring flight operational parameters in accordance with the user-defined monitoring rules. As shown in FIG. 4, in some embodiments, the computing system 101 (e.g., via the predictive computing entity 106 thereof) may create 402 and/or implement one or more monitoring rules. In some embodiments, the computing system 101 may create and/or implement one or more monitoring rules based on input from an external client. In some embodiments, the computing system 101 may receive a rule creation request comprising one or more monitoring rules and implement the one or more monitoring rules, as further described below. In some embodiments, the external client may be an entity, other than the pilot, that possesses the requisite permission(s) and/or authority to request implementation of a monitoring rule. Examples of such external client may be a ground system, an air traffic control member, airline ground staff, or the like. It will be understood that the above examples of an external client are not intended to be limiting and an external client may include other entities. In some embodiments, the rule creation request comprises a request to implement one or more monitoring rules specified in the rule creation request. The rule creation request may comprise one or more rule activation conditions and/or one or more rule triggering conditions that define the one or more monitoring rules. For example, the rule creation request may include a rule name, rule description that describes the rule activation condition(s), and rule triggering details that describes the one or more rule triggering conditions. A monitoring rule may be a temporary rule that specifies one or more flight operational parameters to be monitored against one or more rule triggering conditions during a particular flight operation of an aircraft. Examples of flight operational parameters include, but is not limited to, flight path angle, bank angle, lateral path cross track error, flight path coverage, position sensors, or the like.

The monitoring rule may comprise the one or more flight operational parameters to be monitored and may define conditions for monitoring the one or more flight operational parameters. In some embodiments, such conditions defined by a monitoring rule include rule activation conditions and rule triggering conditions. For example, a monitoring rule may include one or more rule activation conditions and/or one or more rule triggering conditions. The one or more rule activation conditions may describe one or more specified conditions for the particular flight operation and whose occurrence is specified as the trigger to activate the monitoring rule (e.g., to start monitoring one or more specified operational parameters for the particular flight operation against one or more specified rule triggering conditions). In some embodiments, the one or more rule activation conditions may describe the state, time, event occurrence, or the like when a given rule should be activated (e.g., when the computing system 101 should start monitoring the one or more flight operational parameters specified by the monitoring rule). For example, a rule activation condition may comprise temporal data that describes when a monitoring rule should be activated.

Examples of flight activation conditions include, but is not limited to, descent position, where the monitoring rule should be activated when the aircraft transitions to the descent position, aircraft phase, where the monitoring tule should be activated when the aircraft is in the specified aircraft phase (e.g., cruise, taxing, or the like). Aircraft position, where the monitoring rule should be activated when the aircraft is at a specified aircraft position (e.g., airborne, ground, or the like). Examples of triggering conditions include flight path angle exceeds N degrees (e.g., N=6, 10, 20, etc.), bank angle exceeds N degrees, lateral path cross track error exceeds 2 NM, flight path completion rate (e.g., 50% completed, etc.).

The computing system 101 (e.g., via the predictive computing entity 106 thereof) may transmit 404 signals, data, or the like indicative of a rule creation request to a client computing entity 102 associated with the aircraft or otherwise one or more crew members (e.g., pilot, or the like). For example, the client computing entity 102 may be onboard the aircraft. The pilot for the particular flight operation may receive the rule creation request from the computing system 101 via the client computing entity 102. In some embodiments, the rule creation request may originate from an external client, as described above. For example, the computing system 101 may receive a rule creation request from an external client (e.g., from a user device associated with an external client) and transmit signals, data, or the like corresponding to the rule creation request to a client computing entity 102 associated with the aircraft (e.g., to one or more crew members, such as the pilot, via the client computing entity 102). In some embodiments, the rule creation request may include a request for acknowledgment, agreement, consent, or the like from the pilot to authorize implementation of the monitoring rule (e.g., a request to monitor the one or more flight operational parameters during the particular flight operation).

The pilot via the client computing entity 102 may transmit a response indicative of acceptance or rejection of the monitoring rule created by the computing system 101. For example, the computing system 101 (e.g., via the predictive computing entity 106 thereof) may receive a positive response indicative of acknowledgment/acceptance to implement the monitoring rule created by the computing system 101. In some examples, the computing system 101 (e.g., via the predictive computing entity 106 thereof) may receive a negative response indicative of a rejection of the monitoring rule.

The computing system 101 (e.g., via the predictive computing entity 106 thereof), in response to receiving a positive response, may be configured to monitor 408 the one or more rule activation conditions associated with the monitoring rule. For example, the computing system 101 may be configured to periodically or continuously check whether the one or more rule activation conditions have been satisfied.

The computing system 101 may be configured to, in response to determining that the one or more rule activation conditions have been satisfied, monitor 410 the one or more flight operational parameters specified by the monitoring rule. For example, the computing system 101 (e.g., predictive computing entity 106 thereof) may be configured to start monitoring the one or more flight operational parameters with respect to the one or more rule triggering conditions in response to determining that the one or more rule activation conditions have been satisfied. For example, the computing system 101 may be configured to periodically or continuously sample measured data for the flight operational parameters to determine if the operational parameters satisfy the triggering conditions. In some embodiments, the computing system 101 may be configured to, periodically or continuously, sample the output of one or more monitoring systems, monitoring devices, or the like configured to measure and/or collect measured data for various flight operational parameters, including the one or more flight operational parameters specified by the monitoring rule. In some embodiments, the monitoring system is the connected flight management system 110. For example, monitoring the one or more flight operational parameters with respect to the one or more triggering conditions may comprise accessing measured data collected for the one or more flight operational parameters by the connected flight management system 110 and comparing the measured data to the one or more triggering conditions to determine 412 if the measured data for the one or more flight operational parameters satisfy the one or more rule triggering conditions. Accessing the measured data may comprise retrieving the measured data for the one or more flight operational parameters from the connected flight management system 110.

The computing system 101 may be configured to, in response to determining 414 that the one or more rule triggering conditions is satisfied, generate a message output in response to determining that the measured data for the one or more parameters satisfies the one or more rule triggering conditions. In some embodiments, the message output comprises one or more of an advisory message, an alert message, a reminder message, and/or the like configured to, for example, provide situational awareness for the flight crew such as the pilot. The computing system 101 may be configured to cause rendering of a user interface comprising the advisory message on a display of one or more client computing entities 102, an electronic flight bag, and/or the like.

In some embodiments, the computing system 101 (e.g., via the predictive computing entity 106) may transmit 418 a message delivery request to the aircraft system 104 (e.g., via a client computing entity 102 associated with a crew member such as a pilot or via the electronic flight bag 112) prior to rendering the user interface. The computing system 101 may be configured render the user interface in response to an indication of a selection from a user indicating confirmation to render the advisory message (e.g., render the user interface comprising the advisory message). In some embodiments, the one or more monitoring rules is deleted or otherwise removed from a memory associated with the computing system 101 and/or aircraft system 104 after completion of the flight operation and/or in response to a rule deletion indication from the aircraft system 104 (e.g., from a client computing entity 102 thereof).

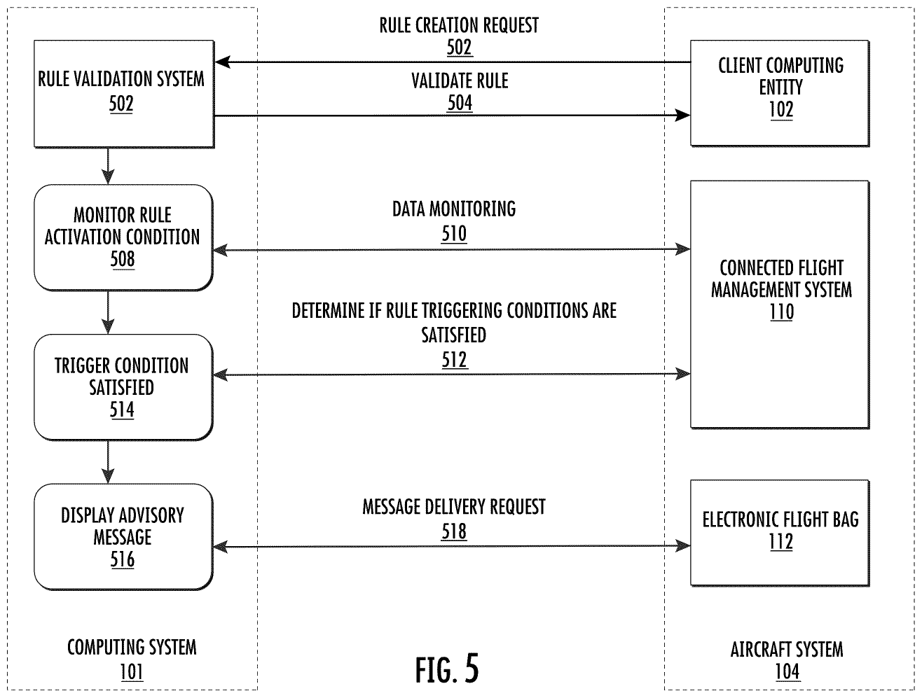

FIG. 5 is a signal diagram of an example process for improved flight operation monitoring. Specifically, FIG. 5 illustrates a signal diagram of an example process for creating user-defined monitoring rules originating from a user, such as the pilot, and monitoring flight operational parameters in accordance with the user-defined monitoring rules. As shown in FIG. 5, in some embodiments, the computing system 101 (e.g., via the predictive computing entity 106 thereof) receives 502 a rule creation request from a client computing entity 102. The client computing entity may be associated with a crew member such as a pilot. For example, the pilot via the client computing entity 102 may create a monitoring rule and transmit a rule creation request comprising the monitoring rule to the computing system 101.

The rule creation request may comprise a request to implement one or more monitoring rules specified in the rule creation request. As described above with reference to FIG. 4, the rule creation request may comprise one or more rule activation conditions and/or one or more rule triggering conditions that define the one or more monitoring rules. For example, the rule creation request may include a rule name, rule description that describes the rule activation condition(s), and rule triggering details that describes the one or more rule triggering conditions. As described above, with reference to FIG. 4, the one or more monitoring rules may comprise temporary rules configured to monitor one or more flight operational parameters during a particular flight operation.

The computing system 101 (e.g., via the predictive computing entity 106 thereof) may be configured to validate 504 the one or more monitoring rules received from the client computing entity 102. In some embodiments, the computing system 101 (e.g., via the predictive computing entity 106 thereof) may leverage one or more rule validation algorithms to validate the one or more monitoring rules. For example, the computing system 101 may perform the validation operation with respect to the one or more monitoring rules received from the client computing entity 102 to verify that the rule activation conditions and/or rule triggering conditions specified in the one or more monitoring rules are reasonable or otherwise satisfy one or more validation criteria. In some embodiments, the one or more monitoring rules received from the client computing entity 102 may originate from a user (e.g., pilot, or the like) onboard the aircraft. In such embodiments, the one or more monitoring rules received from the client computing entity 102 originates associated with the client computing entity 102 may originate from a user that is not on board the aircraft such as an air traffic controller member. In such embodiments, the client computing entity 102 may not be onboard the aircraft.

The computing system 101 (e.g., via the predictive computing entity 106 thereof), may be configured to monitor 508 the one or more rule activation conditions specified in the monitoring rule (e.g., after validating the one or more monitoring rules). For example, the computing system 101 may be configured to periodically or continuously check whether the one or more rule activation conditions have been satisfied.

The computing system 101 may be configured to, in response to determining that the one or more rule activation conditions have been satisfied, monitor 510 the one or more flight operational parameters. For example, the computing system 101 (e.g., predictive computing entity 106 thereof) may be configured to start monitoring the one or more flight operational parameters with respect to the one or more rule triggering conditions in response to determining that the one or more rule activation conditions have been satisfied. For example, the computing system 101 may be configured to periodically or continuously sample measured data for the flight operational parameters to determine if the flight operational parameters satisfy the triggering conditions specified in the one or more monitoring rules. For example, the computing system 101 may be configured to, periodically or continuously, sample the output of one or more monitoring systems, monitoring devices, or the like configured to collect measured data for various operational parameters, including the one or more flight operational parameters. As described above with reference to FIG. 4, the monitoring system may be the connected flight management system 110. For example, monitoring the one or more flight operational parameters with respect to the triggering conditions may comprise accessing measured data collected for the one or more flight operational parameters by the connected flight management system 110 and comparing the measured data to the triggering conditions to determine 512 if the measured data for the one or more flight operational parameters satisfy the one or more rule triggering conditions. As described above, accessing the measured data may comprise retrieving the measured data for the one or more flight operational parameters from the connected flight management system 110.

The computing system 101 may be configured to, in response to determining 514 that the one or more rule triggering conditions is satisfied, generate a message output in response to determining that the measured data for the one or more parameters satisfies the one or more rule triggering conditions. In some embodiments, the message output comprises one or more of an advisory message, an alert message, a reminder message, and/or the like configured to, for example, provide situational awareness for the flight crew such as the pilot. The computing system 101 may be configured to cause rendering of a user interface comprising the advisory message on a display of one or more client computing entities 102, an electronic flight bag, and/or the like.

In some embodiments, the computing system 101 (e.g., via the predictive computing entity 106) may transmit 518 a message delivery request to the aircraft system 104 (e.g., via a client computing entity 102 associated with a crew member such as a pilot or via the electronic flight bag 112) prior to rendering the user interface. The computing system 101 may be configured render the user interface in response to an indication of a selection from a user indicating confirmation to render the advisory message (e.g., render the user interface comprising the advisory message). In some embodiments, the one or more monitoring rules is deleted or otherwise removed from a memory associated with the computing system 101 and/or aircraft system 104 after completion of the flight operation and/or in response to a rule deletion indication from the aircraft system 104 (e.g., from a client computing entity 102 thereof).

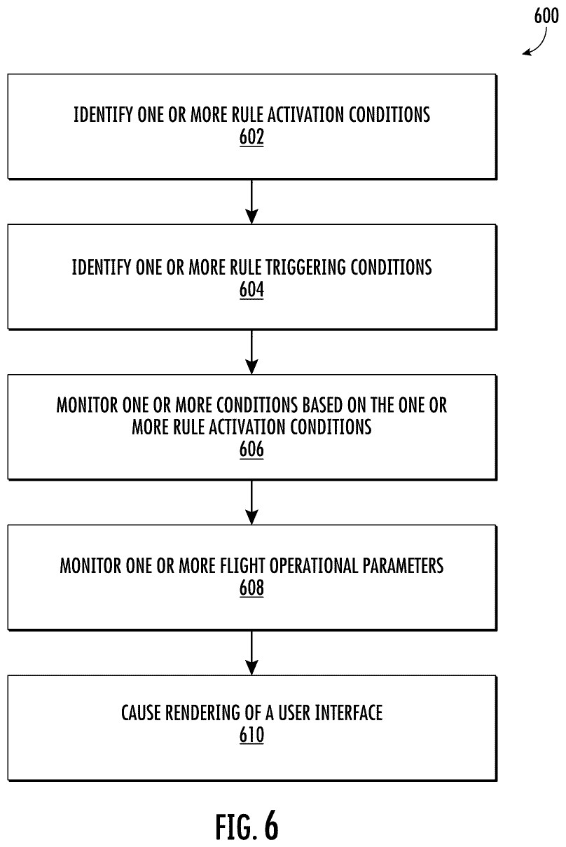

FIG. 6 is a flowchart diagram of an example process 600 for improved flight operation monitoring. The process 600 may be implemented by one or more computing devices, entities, and/or systems described herein. For example, via the various steps/operations of the process 600, the computing system 101 may monitor one or more flight operational parameters in accordance with user-generated monitoring rules and may generate one or more message outputs based on the monitoring.

FIG. 6 illustrates an example process 600 for explanatory purposes. Although the example process 600 depicts a particular sequence of steps/operations, the sequence may be altered without departing from the scope of the present disclosure. For example, some of the steps/operations depicted may be performed in parallel or in a different sequence that does not materially impact the function of the process 600. In other examples, different components of an example device or system that implements the process 600 may perform functions at substantially the same time or in a specific sequence.

In some embodiments, the process 600 includes, at step/operation 602, identifying one or more rule activation conditions associated with a rule creation request. For example, the computing system 101 may identify one or more rule activation conditions associated with a rule creation request for temporary monitoring of one or more flight operational parameters associated with a flight operation.

In some embodiments, the computing system 101 may identify the one or more rule activation conditions based on a rule creation request received from a client computing entity 102. In some embodiments, the computing system 101 may identify the one or more rule activation conditions based on a rule creation request originating from an external client, as described above. For example, the rule creation request may include the one or more rule activation conditions, wherein the computing system 101 may extract the one or more rule activation conditions from the rule creation request or otherwise determine the one or more rule activation conditions from the received rule creation request.

In some embodiments, the computing system 101 may automatically create the one or more rule activation conditions. For example, the computing system 101 may automatically create a monitoring rule that includes the one or more rule activation conditions. In some embodiments, such as where the rule creation request originates from an external client or otherwise automatically created by the computing system 101, identifying the one or more rule activation conditions may include transmitting a rule creation request for a monitoring rule comprising the one or more rule activation conditions to a client computing entity 102 for acknowledgment, consent, or the like from a crew member (e.g., pilot) associated with the client computing entity 102 to proceed with implementing the monitoring rule.

In some embodiments, the process 600 includes, at step/operation 604, identifying one or more rule triggering conditions associated with the rule creation request. In some embodiments, the computing system 101 may identify the one or more rule triggering conditions based on a rule creation request received from a client computing entity 102. In some embodiments, the computing system 101 may identify the one or more rule triggering conditions based on a rule creation request originating from an external client. The rule creation request for example, may include the one or more rule triggering conditions, wherein the computing system 101 may extract the one or more rule triggering conditions from the rule creation request or otherwise determine the one or more rule triggering conditions from the received rule creation request.

In some embodiments, the computing system 101 may create the one or more rule triggering conditions. For example, the computing system 101 may create a monitoring rule that includes the rule triggering conditions. In some embodiments, such as where the rule creation request originates from an external client or otherwise automatically created by the computing system 101, identifying the rule triggering conditions may include transmitting the rule creation request (e.g., described above with reference to step/operation 604), where the monitoring rule comprises the rule triggering conditions (e.g., and the one or more rule conditions) to a client computing entity 102 for acknowledgment, consent, or the like from a crew member (e.g., pilot) associated with the client computing entity 102 to proceed with implementing the monitoring rule. In some embodiments, the one or more rule triggering conditions comprises threshold values for the one or more flight operational parameters.

In some embodiments, the process 600 includes at step/operation 606, monitoring one or more conditions based on the one or more rule activation conditions. For example, the computing system 101 may monitor one or more conditions based on the rule activation conditions to determine whether the one or more conditions satisfy the one or more rule activation conditions by comparing the one or more conditions to the one or more rule activation conditions. For example, if the rule activation is when the aircraft is airborne, the one or more conditions may comprise the position of the aircraft, wherein the computing system 101 may periodically or continuously monitor the position of the aircraft to determine when the aircraft is airborne.

The computing system 101 may be configured to initiate monitoring of the one or more flight operational parameters when the one or more conditions satisfy the one or more rule activation conditions. In some embodiments, a rule validation operation is performed with respect to the rule triggering conditions and/or one or more rule activation conditions prior to determining whether the one or more conditions satisfy the one or more rule activation conditions.

In some embodiments, the process 600 includes at step/operation 608, monitoring the one or more flight operational parameters in response to determining that the one or more conditions satisfy the one or more rule activation conditions and based on the one or more rule triggering conditions. The computing system 101 may monitor the one or more flight operational parameters based on the rule triggering conditions by periodically or continuously comparing measured data for the one or more flight operational parameters to the one or more rule triggering conditions. In some embodiments, the computing system 101 accesses measured data for the one or more flight operational parameters and compares the measured data with the one or more rule triggering conditions. In some embodiments, the measured data may be obtained from a monitoring system such as a connected flight management system 110. For example, monitoring the one or more flight operational parameters may comprise accessing measured data for the one or more flight operational parameters from the connected flight management system and comparing the measured data to the one or more rule triggering conditions. Accessing the measured data may comprise retrieving the measured data for the one or more flight operational parameters from the connected flight management system 110.

In some embodiments, the process 600 includes at step/operation 610, causing rendering of a user interface comprising a message when the one or more flight operational parameters satisfy the rule triggering conditions. In some examples, the message may comprise an advisory message. In some examples, the message may comprise an alert message. In some embodiments, the message may comprise a reminder message. It will be understood that the message may comprise other message types.

An example application of embodiments described herein include a flight path angle rule where the there is a desire to trigger flight path angle beyond certain degrees to indicate steep path. In such examples, the flight operational parameters to monitor comprise flight path angle, the rule activation condition may comprise when the flight phase transitions to descent, and the rule triggering condition may comprise when the flight path angle exceeds certain limit such as, for example, 6 degrees. In such examples, alerting message may be provided in the electronic flight bag to the pilot.

Another example application of embodiments described herein include a wide turn rule. In such examples, the flight operational parameters may include bank angle, the rule activation condition may be when the aircraft is airborne, and the rule triggering condition may be bank angle more than 20 degrees. In such examples, an advisory message may be provided when the bank angle is more than 20 degrees.

Another example application of embodiments described herein includes lateral path cross track error, wherein the pilot wants to monitor lateral path cross track error and wants to be notified if the lateral path cross track error is more than 2 nm during bad weather condition. In such example, the flight operational parameter may be the lateral path cross track error, the rule activation condition may be the flight phase (e.g., cruise), and the rule triggering condition may be cross track error more than 2 nm.

Another example application of embodiments described herein includes flight path completion rule where the pilot can create a rule to be notifies when 50% of the flight path is completed to ensure the systems are on track. This rule, for example, can be customized as per pilot needs (e.g., like nearing to top of descent with certain distance).

Another example application of embodiments described herein includes position sensor rule, where the pilot can create a rule to receive position alert when there is a variance within the position sensors during various flight phases. In such example, the rule activation may be when the flight management system position and position sensors differ by provided tolerance.

### CONCLUSION

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method for improved flight operation monitoring, the computer-implemented method comprising:
identifying one or more rule activation conditions associated with a rule creation request for temporary monitoring of one or more flight operational parameters associated with a flight operation;
identifying one or more rule triggering conditions associated with the rule creation request;
monitoring one or more conditions based on the one or more rule activation conditions by comparing the one or more conditions to the one or more rule activation conditions;
in response to determining that the one or more conditions satisfy the one or more rule activation conditions, monitoring the one or more flight operational parameters based on the one or more rule triggering conditions by comparing the one or more flight operational parameters to the one or more rule triggering conditions; and
causing rendering of a user interface comprising an alert message when the one or more flight operational parameters satisfy the one or more rule triggering conditions.

2. The computer-implemented method of claim 1, wherein the one or more rule triggering conditions comprises threshold values for the one or more flight operational parameters.

3. The computer-implemented method of claim 1, wherein monitoring the one or more flight operational parameters comprises:
accessing measured data for the one or more flight operational parameters; and
comparing the measured data to the one or more rule triggering conditions.

4. The computer-implemented method of claim 3, wherein accessing the measured data for the one or more flight operational parameters comprises retrieving the measured data for the one or more flight operational parameters from a flight management system.

5. The computer-implemented method of claim 1, further comprising:
receiving the rule creation request; and
creating one or more monitoring rules based on the rule creation request.

6. The computer-implemented method of claim 5, wherein the one or more monitoring rules comprise one or more user-defined monitoring rules.

7. The computer-implemented method of claim 1, further comprising:
performing a rule validation operation with respect to the one or more rule triggering conditions before determining whether the one or more conditions satisfy the one or more rule activation conditions.

8. The computer-implemented method of claim 1, further comprising:
receiving, via the user interface, an indication of a selection from a user indicating confirmation to render the user interface.

9. A computing system for improved flight operation monitoring, the computing system comprising memory and one or more processors communicatively coupled to the memory, the one or more processors configured to:
identify one or more rule activation conditions associated with a rule creation request for temporary monitoring of one or more flight operational parameters associated with a flight operation;
identify one or more rule triggering conditions associated with the rule creation request;
monitor one or more conditions based on the one or more rule activation conditions by comparing the one or more conditions to the one or more rule activation conditions;
in response to determining that the one or more conditions satisfy the one or more rule activation conditions, monitor the one or more flight operational parameters based on the one or more rule triggering conditions by comparing the one or more flight operational parameters to the one or more rule triggering conditions; and
cause rendering of a user interface comprising an alert message when the one or more flight operational parameters satisfy the one or more rule triggering conditions.

10. The computing system of claim 9, wherein the one or more rule triggering conditions comprises threshold values for the one or more flight operational parameters.

11. The computing system of claim 9, wherein the one or more processors are further configured to monitor the one or more flight operational parameters by:
accessing measured data for the one or more flight operational parameters; and
comparing the measured data to the one or more rule triggering conditions.

12. The computing system of claim 11, wherein the one or more processors are further configured to access the measured data for the one or more flight operational parameters by retrieving the measured data for the one or more flight operational parameters from a flight management system.

13. The computing system of claim 9, wherein the one or more processors are further configured to:
receive the rule creation request; and
create one or more monitoring rules based on the rule creation request.

14. The computing system of claim 13, wherein the one or more monitoring rules comprise one or more user-defined monitoring rules.

15. The computing system of claim 9, wherein the one or more processors are further configured to:
perform a rule validation operation with respect to the one or more rule triggering conditions before determining whether the one or more conditions satisfy the one or more rule activation conditions.

16. The computing system of claim 9, wherein the one or more processors are further configured to:
receive, via the user interface, an indication of a selection from a user indicating confirmation to render the user interface.

17. At least one non-transitory computer-readable storage medium for improved flight operation monitoring, the at least one non-transitory computer-readable storage medium having computer coded instructions configured to, when executed by at least one processor:
identify one or more rule activation conditions associated with a rule creation request for temporary monitoring of one or more flight operational parameters associated with a flight operation;
identify one or more rule triggering conditions associated with the rule creation request;
monitor one or more conditions based on the one or more rule activation conditions by comparing the one or more conditions to the one or more rule activation conditions;
in response to determining that the one or more conditions satisfy the one or more rule activation conditions, monitor the one or more flight operational parameters based on the one or more rule triggering conditions by comparing the one or more flight operational parameters to the one or more rule triggering conditions; and
cause rendering of a user interface comprising an alert message when the one or more flight operational parameters satisfy the one or more rule triggering conditions.

18. The at least one non-transitory computer-readable storage medium of claim 17, wherein the one or more rule triggering conditions comprises threshold values for the one or more flight operational parameters.

19. The at least one non-transitory computer-readable storage medium of claim 17, wherein the computer coded instructions are further configured to, when executed by at least one processor monitor the one or more flight operational parameters by:
accessing measured data for the one or more flight operational parameters; and
comparing the measured data to the one or more rule triggering conditions.

20. The at least one non-transitory computer-readable storage medium of claim 19, wherein the computer coded instructions configured to, when executed by the at least one processor to access the measured data for the one or more flight operational parameters by retrieving the measured data for the one or more flight operational parameters from a flight management system.
